(19) United States
(12) Patent Application Publication
(10) Pub. No.: US 2016/0071367 A1
(43) Pub. Date: Mar. 10, 2016

(54) WEIGHT VALUATION OF MIXTURES OF CHIPS ON A GAMING TABLE

(71) Applicant: Mark A. LITMAN, Edina, MN (US)

(72) Inventor: Mark A. LITMAN, Edina, MN (US)

(21) Appl. No.: 14/480,618

(22) Filed: Sep. 8, 2014

(51) Int. Cl. G07F 17/32

(52) U.S. Cl. CPC G07F 17/3232; G07F 17/3244

(57) ABSTRACT

A method of determining total values of wagers, payouts or cashed-in chips at a single player's wagering position on a gaming table has steps of: a) providing a set of at least three different value wagering chips having different values in subsets of chips, each subset of chips having relative non-rational weight values, b) placing chips at a least one weighing position with at least one chip from a subset of chips, c) weighing the wager placed at the at least one weighing position, and d) accurately determining a total value of wagers made at the at least one weighing system based on unique correspondence between weight and value among each subset of chips, wherein each subset of chips has non-rational weights such that for any combination of ten chips from each of the at least three subsets of chips, there is a unique weight.

### BACKGROUND OF THE INVENTION

1. Field of the Invention

The present invention relates to the field of table gaming, the use of chips on gaming tables and collective weighing of chips of different values to provide an accurate valuation of a total wager.

2. Background of the Art

Gaming technology has been moving towards electronic control of the gaming environment for many years. Electromechanical card shufflers, electromechanical chip counters, card reading functionalities on shufflers and table tops, chip reading and the like have advanced the systems towards the ultimate goal of near total information control. It has actually been the valuation of stacks of chips that has proven to be either the most costly (because of the use of RFID chips, transducers, or other electronic responsive or measurable elements embedded in chips) and/or the most complex (e.g., multiple-angle cameras with color-reading or edge-marker reading technology).

Weight and weighing have been used in only a limited fashion to determine presence, numbers or value of chips used at a gaming table.

U.S. Pat. No. 7,559,839 (Bahar) discloses numerous methods for sensing activity at a gaming table. There is a single example with exactly two chips of different weights being collectively weighed to determine an absolute value. Once all betting is finalized, the detected monetary value of the players' bets is locked and/or recorded thereby preventing that value from being changed by the addition or removal of betting chip(s) from a player's respective bet. If after the results of the gaming round, there is a discrepancy or mismatch between a player's wager and the locked monetary value of a player's bet, casino personnel will be alerted of the player's possible cheating practices thereby enabling them to investigate the matter.

Other patent documents disclose various forms of non-weight consideration sensing except for presence sensing to identifying that a wager has been placed, such as U.S. Pat. No. 8,795,061 (Burrill); U.S. Pat. No. 8,465,364 (Kuhn); Wolf (8,277,314); and 8,333,652 (Nguyen).

In other environments, chips may be separated by value and weighed when they have identical weights or different weights (8,157,643); U.S. Pat. Nos. 5,451,054 and 7,351,145 (Orenstein).

In still other systems, electronic, visual or electronic (radiation or magnetism) responsive chips are provided on a gaming table and automatically read individual chips on a gaming table as disclosed in U.S. Pat. No. 5,166,502 (Rendleman); U.S. Pat. No. 5,770,533 (Franchi); U.S. Pat. No. 6,200,218 (Lindsay); U.S. Pat. No. 6,629,889 (Mothwurf); U.S. Pat. No. 6,873,355 (Thompson); U.S. Pat. No. 7,404,765 (Soltys); and 8,777,730 (Koyama).

A simpler method with reasonable cost chips is still a desired objective in the gaming industry. All documents cited herein are incorporated by reference in their entirety.

### SUMMARY OF THE INVENTION

A set of gaming chips is provided, with at least three classes of chips being distinguished among each other by each class having both different wagering value and also different weights per chip unit. The weight differentials must be predetermined so that in a stack of at least ten chips, for a given weight total, only a single total value is possible when using at least three classes of wagering chips.

Gaming tables having wager placement areas with independent, high accuracy weighing functionality may be used in combination with the novel gaming chips of the present technology.

The novel weighing functions may be used in combination with other chip sensing technology to assure accuracy and lack of fraud by players and/or casino personnel.

A method of determining total values of wagers, payouts or cashed-in chips at a single player's wagering position on a gaming table according to the present technology includes, for example: a) providing a set of at least three different value wagering chips having different values in subsets of chips, and each subset of chips having relative non-rational weight values, b) placing chips at a least one weighing position with at least one chip from a subset of chips, c) weighing the wager placed at the at least one weighing position, and d) accurately determining a total value of wagers made at the at least one weighing system based on unique correspondence between weight and value among each subset of chips, wherein each subset of chips has non-rational weights such that for any combination of ten chips from each of the at least three subsets of chips, there is a unique weight.

### BRIEF DESCRIPTION OF THE FIGURES

FIG. 1 shows a side cutaway view of a cartridge that can be inserted into a table top at a wagering or payout position to act as a weight sensor according to the present technology.

FIG. 2 shows a side cutaway view of a second cartridge that can be inserted into a table top at a wagering or payout position to act as a weight sensor according to the present technology.

FIG. 3 shows a side view of a gaming table, under-table lighting system and camera system, and weighing system for chips enabling practice of one aspect of the present technology.

FIG. 4 shows a side view of a gaming table, radiation emitter, chips and camera system.

FIG. 5 shows a series of images of gaming chips that have been imaged by penetrating radiation.

### DETAILED DESCRIPTION OF THE INVENTION

The present technology includes components, subcomponents, apparatus, systems and methods as described herein.

One component of the system comprises a set of chips having at least three distinct values and a distinct, relative, non-rational weight uniquely associated with each of the distinct values. The term “distinct, relative, non-rational weight” is defined in detail herein, especially with respect to a minimum number of total chips in a stack, and especially at least 10 chips in a stack.

The system may also include a weighing system associated with each individual wager or payout location with a sensitivity and accuracy sufficient to assure accurate measurement within tolerance parameters of the stack of at least three different value chips with distinct, relative, non-rational weight differences.

In general, a system is enabled for determining values of wagers at a wagering position or payout position. The system may have an electronic weight-sensing system (a system that generates electronic signals that are interpreted by execution of code in a processor) at the wagering position. The system also includes a set of at least three different value wagering chips having different values in at least three subsets of chips, and each subset of chips having relative non-rational weight values within a group of at least 10 chips in the presence of at least one chip from each of the three subsets. The electronic weight-sensing system is in information communication link with a processor, and the processor is configured to determine from transmitted data of the sensed weight at the wagering position actual total value amounts from the wagers in a single stack at the wagering position. The processor may be configured with a look-up table against which sensed weight is compared to determine a unique total value of wagers at the wagering position when multiple chips having different relative non-rational weight values are present at the wagering position, or the processor is configured to execute code with respect to sensed weight to determine a unique total value of wagers at the wagering position when multiple chips having different relative non-rational weight values are present at the wagering position. The system may further have a system for determining values of wagers, awards or cashed-in chips at a wagering position comprising an electronic weight-sensing system at the wagering system, a set of different value wagering chips having different values in subsets of chips, and each subset of chips having relative non-rational weight values, the electronic weight-sensing system in information communication link with a processor, and the processor is configured to determine from sensed weight at the wagering position value amounts from the wagers at the wagering position. A method of determining total values of wagers, payouts or cashed-in chips at a single player's wagering position on a gaming table may be practiced by: a) providing a set of at least three different value wagering chips (as described above) having different values in subsets of chips, and each subset of chips having relative non-rational weight values, b) placing chips at a least one weighing position with at least one chip from a subset of chips, c) weighing the wager placed at the at least one weighing position, and d) accurately determining a total value of wagers made at the at least one weighing system based on unique correspondence between weight and value among each subset of chips. The method may have a number of chips (usually up to a reasonable limit within the tolerances of the distinct, relative, non-rational weight interaction, such as at least three different distinct, relative, non-rational weight chips and preferably up to at least 10, at least 15 or at least 20 chips, with a reasonable limit of up to 25 or 50 chips) at the at least one weighing position is sensed and the number of chips and a total weight of chips at the at least one weighing position are used in combination to determine the total value of wagers made at the at least one weighing position. The method should be functional when at least three chips of at least three different values are weighed at the same time at the at least one wagering position, preferably with four distinct, relative, non-rational weight chips of at least four different values, and at least five distinct, relative, non-rational weight chips of at least five different values. Further explanations of these capabilities and relationships are provided below.

FIG. 1 shows a cartridge or embedded structure 100 having a casing 102, weighing top plate 104, parallel or circumferential weighing plate stops 106, gauge lever 108, sliding contact element 110, conductor/communication link 112, contact point 114 between the gauge lever 108 and the weighing top plate 104, a processor 116 and a hinge 120 for the gauge lever 108. As chips (not shown) are placed on the weighing top plate 108, the gauge lever 108 is bent or rotated to indicate weight of chips on the top plate 108 (as with 108 being a piezoelectric sensor, or the hinge 120 providing weight measurements by degree of rotation. The communication link 112 send weight determining data or signals to the processor 116 to determine total weight of chips on the weight sensing plate.

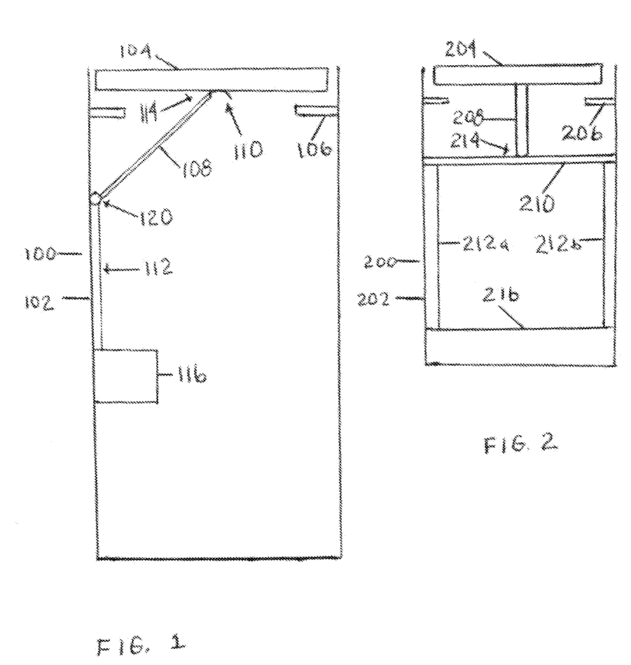

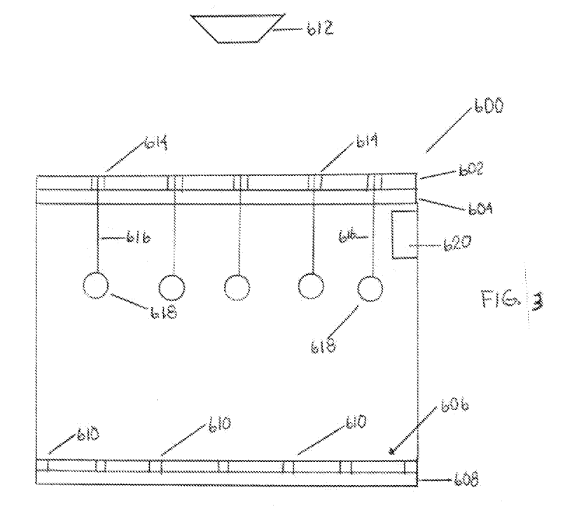

FIG. 2 is an alternative cartridge or embedded structure 200 with a housing 202, top weight sensing plate 204, a piston 208, a flexible compressive (for hydraulic weight measurements) or piezoelectric flexible sensor 210, weighing plate stop 206, with a contact point 214 between piston 204 and the sensor 210. Electrodes 212a 212b send sensed signals from the sensor 210 to a processor 216. If the system measure hydraulic changes from compression, 216 may be a pressure sensor.

The weighing plate stops 106, 206 have multiple functionalities and potentialities. To avoid damage to the system, the weighing plate stops 106, 206 will be at a point in the movement of the weighing top plates 104, 204 that would exceed a reasonable betting limit. For example, if the betting limit at a table were $3,000.00, the weighing plate stops 106, 206 would be at a depth that would indicate an excessive wager. If a player were to attempt to place a $3,000 wager with $5.00 chips (600 chips), a casino would under normal events stop and have the chips colored up to larger denominations as the large number of chips would be unwieldy on the gaming table, so large total amount wagering with smaller denomination chips is already avoided. At a $3,000.00 wager limit, to weighing plate stops 106, 206 would occur, for example, with a weight attributable to one $1,000 chip, fifteen $100 chips and twenty $25.00 chips (for a total of thirty-six chips with a value of $3,000 total. Therefore, as weighing would be done without player contact with the wagering area on a continuous basis (a player touching the area would cause variations in the weight, rather than taking the weight measurement at a steady state, stable, non-fluctuating condition), any unusual force against the weighing plates 104, 106 which could damage the system also would be prevented by the weighing plate stops 106, 206. If a player pressed on the chips intentionally or accidentally by an amount of weight/force that exceeds the predetermined limit of weight allowed on the wagering plates 104, 106, the stops would help the system avoid damaging stress, as would most easily occur in the system 200 shown in FIG. 2.

The weighing plate stops 106, 206 might also include a position/contact sensor (not shown) as part of the top surface of the weighing plate stops 106, 206. The placement of chips with incidental hand pressure might cause transient sensing of excessive weight and activation of the sensor, which would disappear as the plate recovered from transiently applied excess weight. The processor can be programmed to recognize transient weighting errors as the weight returns to a stable balance. Resistance to downward movement (as is typical in many scales) can be provided by biasing pressure from springs, hydraulics and the like.

The interior sides and insides of the cartridge or device should have low friction surfaces, and low wear surfaces, as with controlled smoothness surfaces of metals, composites, polymers, and especially low friction polymer surfaces as substantive material for the interior surfaces or as coatings on other materials. Roller bearings in one or more concentric annular ring arrangements may be used to assist in aligning and controlling glide and friction of the weighing plats 104, 204 as they move from a highest elevation to a lower elevation within the cartridge.

FIG. 3 shows a side cutaway view of a gaming table 600, under-table lighting system 610 and camera system 612, and weighing system 614 for chips enabling practice of one aspect of the present technology. The table 600 has a top infrared translucent/transparent support surface 604 supporting a top layer 602 which may be traditional felt or special IR transparent covering. Individual wagering areas 614 have at least a portion of a weighing system associated therewith, as the weight sensors 618 and their communication link 616 to the weighing areas. Non-wired (e.g., RF) communication links may also be used. At the bottom of the table 600 may be a base support layer 608, supporting a layer 606 having IR light(s) 610 that emit upwardly through layers 604 and 602 to the camera 612.

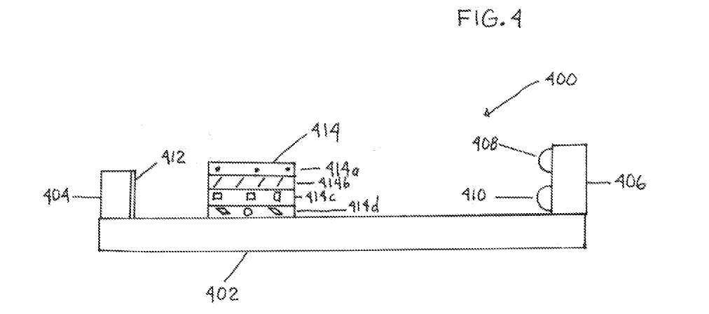

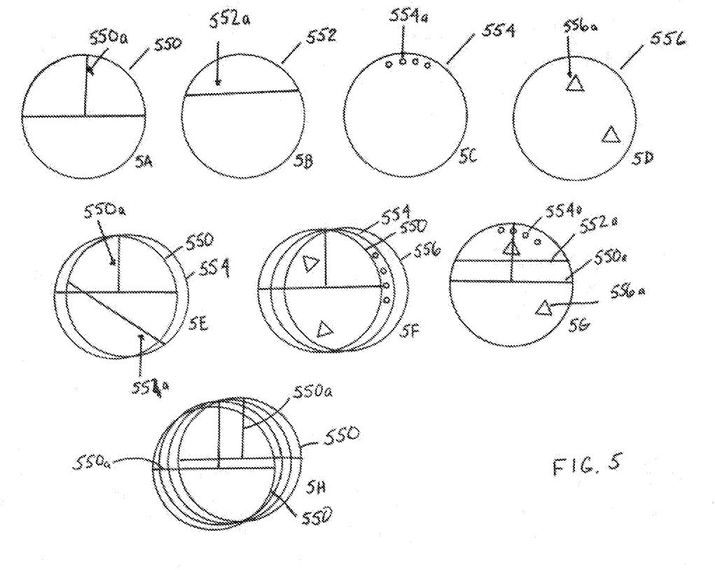

An alternative camera and imaging system, alternative under-table lighting systems and camera system enabling practice of one aspect of the present technology. This gaming system is provided with a radiation transparent or translucent structural support having a radiation penetrable game marking top (such as a felt top) with at least markings thereon to identify placement areas for cards and placement areas for wagers. Variable independent or overlapping structures are shown in FIG. 4 to conserve space. One independent system has an diffuse radiation-emitter 516 below the surface of the structural support so that emitted radiation passes through the game marking top and creates differential optical densities as the radiation passes through the markings and around (if opaque) and through (if transparent or translucent) an object (chip, playing card, identification tag, marker, currency) placed on the game marking top. After the radiation from emitters passes through or around the object (not shown) especially over the markings, it travels as radiation to at least one overhead camera (e.g., an overhead system on the ceiling or supported over the system) where received image data is processed by a computer to identify image content, including playing card rank, suit and content and use that information for display or hand reading, or strategy analysis and/or player comping.

An alternative structure can use a bank or independent numbers of radiation emitters below a radiation transparent support, with the orientation and alignment of the emitters and either a single overhead camera or a bank of overhead cameras that receive the emitted radiation. For example, emitter creates a linear radiation path that passes through the transparent/translucent support base, the marking on the table system to the aligned overhead camera. Similarly, using a single overhead camera, emitter emits the preferred wavelength of radiation through the transparent/translucent support base, the marking on the table system to the aligned overhead camera.

The table system has legs that support the radiation transparent support and the covering. The cameras receive image-content information that passes through objects (e.g., infrared radiation passing through playing cards, cellulosic materials, paper currency, player cards, bar-code tickets, thin transparent polymeric materials, etc.) to provide substantive image content of the object or when passing around the object (e.g., an opaque chip, medallion, coinage etc.) provides object presence information (e.g., at least one chip has been placed at a wagering position).

A system within the scope of this technology may include a table gaming system wherein the source of infrared emitters emits wavelengths within the wavelength range of 800-1200 nanometers is the support surface is transparent to at least infrared radiation between wavelengths of 800 to 1200 nanometers, and the infrared sensitive camera is sensitive to at least some wavelengths between 800 and 1200 nanometers (even to 2300 nm), and wherein the emitters and cameras are aligned so that emitted radiation passes through the support surface and through or around at least one object on the support surface towards the infrared camera in sufficient intensity as to allow for object recognition or see-through reading of the object, The system may include the at least one object as a playing card and at least 5% of incident emitted infrared radiation hitting a surface of the playing card passes through the playing card to the infrared camera. The system may include the at least one object as a wagering token or chip and less than 5% of incident emitted infrared radiation hitting a surface of the playing card does not pass through the object to the infrared camera.

The lighting systems 512 can also be canisters that are replaceable within the table top system (e.g., through holes in the radiation penetrable game marking top 506. In this case, if all illumination is through canisters and their lenses or covers (and does not have to be done through a radiation penetrable game marking top 506 or even through a radiation transparent support 504, neither the game marking top or the support have to be transparent. To see the types of structures similar to those that may be provided as a canister, refer to U.S. Pat. Nos. 6,299,534 and 7,367,884 (Breeding patents) which show optical-electrical devices that have transducers that emit and receive reflected radiation, These types of devices can be used as emitters and the reflected radiation receiving capability can (and should) be eliminated. In this way, the canisters operate as sources of emitted radiation according to the practice of the present technology by providing the IR radiation source (e.g., 700 to 2300 nm) as IR emitters, such as IR LEDs. Canisters similar to those of FIGS. 7, 8, 9 and 10 of U.S. Pat. No. 7,367,884 (with or without the necessity of a requirements of sensing capability in the canister) can be used in the practice of the present invention.

Additionally, canisters may be provided with weight sensing capability to assist in determining the presence of heavier objects, such as chips or tokens provided on the surface of the emitters. This is useful where the emitters are used in locations where wagers must be positioned. Weight sensing elements such as scales, springs, flexing sensors, pressure sensors, force sensors, and the like may be incorporated easily in the canisters, especially along or under the housing 136 or cover plate or token supporter 138 shown in FIGS. 7 and 8 of U.S. Pat. No. 7,367,884. The weight sensing device would be in electrical or wireless communication with a processor to receive information. As chips at a specific location tend to be a uniform weight, the steady weight registered at a specific wagering position can be quantified into a specific number of chips. This is especially useful in roulette, where all tokens for a player usually have the same nominal value, so that identifying a specific number of chips also identifies a specific value for each wager. The weight sensing component may also be a flexible piezoelectric resistor having at least two cathodes thereon. When current passes through the piezoelectric resistor, and as pressure (e.g., weight) changes on the resistor, the current changes. This type of weight/pressure indicating and measuring technology is shown in U.S. patent No. U.S. Pat. No. 8,132,468 (Radivojevic). These piezoelectric sensors comprise nanotubes or nanofilaments in an elastic carrier layer. Another aspect of this weight measuring technology is the used of chips of different values with individual different weights. The sensitivity of the pressure-sensing elastic, nanofilament systems is so great, and the calculating capability of associated processors so rapid (by algorithm execution or by resorting to stored look-up tables) that values of chips of different weights can be determined by the total weight of chips on a stack. For example, if 1-unit value chips have a weight of 1.00 weight units, 5-unit value chips have a weight of 1.03 weight units, 25-unit value chips have a weight of 1.07 weight units and 100-unit value chips have a weight of 1.11 weight units, the total weight of combinations of chips can be immediately converted to total values of chips as the weighing accuracy of these system is with over 0.0001% accuracy, and the non-relative weights with reasonable numbers of chips being used (wagers are usually 10 or fewer chips or 20 or fewer chips), there can be no reasonable likelihood of error. That is, for wagers using multiple chips, an equal weight for wagers of only 5-unit wager chips and only 25-unit wager chips would occur only with 107 5-unit wager chips and 103 25-unit wager chips (both amounts being 110.21 weight units). Even this potential overlap could be avoided by using less ‘rounded’ weights for chips, such as 1.031 weight units or 1.073 weight units. For purposes of the present invention definition, this is referred to as the use of non-rational weight values within a number range of chips, such as within 10 chips at a time, 20 chips at a time, 50 chips at a time, 100 chips at a time, within 200 chips at a time, within 500 chips at a time, or within at least 1,000 chips at a time. “Non-rational weight values” or “relative non-rational weight values” means that with weighing capability with at least a significant tolerance or accuracy for weighing chips within small percentages of accuracy, such as at least 0.005% or at least 0.001% accuracy, no combination of numbers of at least two chips of at least one or more within the asserted number range can have the same weight for any number of those at least two chips. This may apply for combinations of three chips, combinations of four chips and combinations of at least five chips to create a non-rational weight value system for wagers of up to ten chips, up to 20 chips, up to 50 chips, up to 100 chips or more. These would require specially manufactured chips, and the higher value chips should be higher weights than lower value chips so that shaving chips could not increase the sensed value of a chip. This system could also assist in detecting chip fraud, as the weights of chips are another indication of authenticity in addition to physical appearance. Also, when weights of chips vary from predetermined weight parameters (wear on chips and collection of dirt would promote chip replacement and cleaning, and would be somewhat visually observable), this would motivate dealers and croupiers and other pit personnel to inspect the chips. Larger absolute weights of chips may also be used, and non-rationality maintained. Larger weights such as 1.0 units for 1 wagering unit, 1.3 units for 5-unit value wagers, 1.7 weight units for 25-wagering unit value wagers, and 2.9 weight units for a 100-unit value wager. The use of weighing, possibly in combination with visual imaging, either through the chips as described herein, or with standard side view camera imaging can be used to determine absolute values of wagers at betting positions. For example, there is only one total value that can exist for a combination of 5 chips that have a total weight of 7.9 weight units (2×5-value, 2×25-value and 1×100 value for a total of 160-value). The larger weight units make wear and dirt collection less critical.

A lookup table for all possible combinations of numbers of the at least three, at least four or at least five different value chips with non-rational weight values is preferable, with total numbers of chips of at least up to 10, at least up to 15 and at least up to 20. As the weight combinations are unique, especially easily determined when numbers of chips are known, the lookup table is a simple component of the system. The lookup table may be used in a number of ways in addition to looking up specific wager totals. If a weight total does not exactly (within weight tolerances of the weighing system) match a theoretic value within the table, this can alert the dealer/casino of the potential for fraud. The system may also operate as a “nearest match” source of resolution of the total wager value determination, with the nearest match presumptively the next lower total wager value between the two nearest weights in the lookup table. Especially if a visual display of the value of the wager is provided to the player at the player position (with a small screen, for example) at the player position, the player is then given an opportunity to possibly challenge the reading of the wager. The processor would transmit the total wager amount at that player position to a locally viewable (by the player) for that wager to provide that challenge opportunity. The amounts of wagers can be displayed on a larger screen or made available to an audience, as when there is a tournament being played. In the closest match scenario, if the default to the lowest value of total wager is not used, the weight measured closest to a theoretically possible weight on the lookup table can be used as a default function. For example, if theoretical weights includes only 5.13, 5.18, 5.23, and 5.27 units of weight, and the measured weight was 5.19 units of weight, the total Value would default to the total value associated exclusively with the 5.18 weight units in the look-up table.

It is also desirable to calibrate the system on a reasonably regular basis, such as at least every day, every shift change (e.g., three times a day), or even every hour. Calibration could take less than a minute and be performed during shuffling of playing cards. The calibration could be done with standardized control chips or weights placed on the weighing area and the response evaluated by the processor. The calibration need be done only on a single one of each value of chip and at least two different (possibly randomly selected or standard) combinations of three or four values of chips.

Existing equipment that is known (and referenced above) to weigh single values of chips can be used to provide additional security against alterations in weights of specific value chips. By having the largest value chips have higher unit weights, alteration of the chips in a manner more favorable to players would be more difficult. Adding significant weight to chips would be more easily visually observable and therefore readily detectable. Also, attempting to precisely alter the weight of chips would be complex and likely to cause the processor to identify total weight values that are not theoretically possible. Attempting to add weight might also significantly alter the appearance of wagering chips and make alteration noticeable, whether by “shaving” the chips or by “pasting” weight onto the chips, the alteration could also be readily visibly observable. By designing chips with very smooth major (circular cross-section) surfaces, with unique and even graded (rainbow colored or shifting intensity or tone of individual colors), addition of weight or shaving chips might be rendered further observable by the naked eye or by surveillance cameras (general ‘eye-in-the-sky’ cameras or cameras having specific tone/color/shade/pattern recognition capability).

An additional structural component assisting in the valuation of a stack of chips (in combination with the weighting system) is a system 400 shown in FIG. 4. A system 400 is shown with a chip number counting capability with a table top 402, player side ridge 404 (which may have imaging capability 412 or alternatively the dealer side imaging system 406, 408 and 410 now described). On the dealer side of the table top[402 is shown a raised support 406, radiation emitter (UV, visible IR or combination) and a radiation receiving camera 410. A stack of chips 414 with individual value chips 414a, 414b, 414c and 414d possibly having (or not) unique visual external markings thereon that can be readily identified automatically by a processor (not shown) in communication with the camera 410. In a typical system operation, the chips are weighed by systems of FIG. 1 or FIG. 2 (for example), radiation is emitted by emitter 408, the radiation is partially reflected by the stack of chips 414 and the reflected radiation is received by the camera 410. The camera identifies a number of chips, which number can be assisted in distinction (with or without assisting identification of unique chip value) to provide the number of chips in the stack of chips 414. The weight of the stack of chips Ws and the number of chips in the stack Cs are used according to the following formulae in concert to determine a total value Vt of the chips in the stack:

Vt=Ca(Va)=Cb(Vb)+Cc(Vc)+Cd(Vd) Formula 1

wherein Ca, Cb, Cc and Cd represent numbers of chips of specific values of Va, Vb, Vc and Vd, respectively and

Cs=Ca=Cb+Cc+Cd. Formula 2

For each Ws, there is a unique solution for each of these equations when the chips are non-rationally weighted, the weight of the chips are known and the total number of chips are known such that for any specific Ws (determined by the weighing system), and known Cs (determined by the camera system or even dealer input), there is a unique solution of Vs for that combination of Ws and Cs. This modality should easily hold true for Cs≦10; Cs≦15; Cs≦20 for the system to be useful. Cs may be higher than 20, but the weighing system may have to be too precise. The weighing system should have tolerances and precision within at least ±1.0 percent, preferably within ±0.75 percent, within ±0.50 percent, within ±0.25 percent, within ±0.10%, within ±0.075%, within ±0.50% and even within ±0.010% or less, depending upon the differentiation in weight among the at least three and preferably at least four values of chips.

It is to be noted that instead of a radiation emitting system 408, ambient visible light or ambient IR or ambient UV radiation may be received by the camera system 410. The method may therefore determine numbers of chips automatically identified by an image capture system.

An example of rational weight differences within a combination of four chips would be, for example, chips having values and weights of 0.5 weight units for 1-value unit, 1.0 weight units for 5-value units, 1.5 weight units for 25-value units and 2.0 weight units for 100 value units. With these weights, 4 chips having a weight of 4.0 weight units could have values of 52 value units (2×0.5 and 2×1.5 weight units equals 52 value units); 126 units (1×2.0 weight units, 1×1.5 weight units and 1×0.5 weight units); and 110 value units (1×2.0 weight units and 2×1.0 weight units equals).

Therefore, a method is described herein for weighing collections of chips, each individual value chip having a different non-rationally related weight of any other value chip, and the weight sensing component on the gaming table sending data relating to total weight at a wagering position to a processor, and the processor, by executing of an algorithm or use of a game table, determine an actual value for the wager on the wagering position. A look-up table would function by having all possible weight combinations up to a specific total number of chips (e.g., twenty chips), and upon receiving information on actual total weight, determining from the look-up table, the actual value of chips wagered according to unique weight measurements. A simple example of a look-up table is:

TABLE 1

| TOTAL | | TOTAL VALUE |
|---|---|---|
| WEIGHT | CHIP COMBINATION | WAGERED |
| 1.0 | 1-UNIT VALUE | 1 UNIT |
| 2.03 | 1-UNIT AND 5-UNIT CHIPS | 6 UNITS |
| 2.07 | 1-UNIT AND 25-UNIT CHIP | 26 UNITS |
| 2.10 | 5-UNIT AND 25-UNIT CHIP | 30 UNITS |
| 4.10 | 2x 1 UNIT, 5-UNIT AND 25- | 32 UNITS |
| | UNIT CHIPS | |
| 4.24 | 3x25 UNIT, 5-UNIT | 80 UNITS |
| 4.28 | 4x25-UNIT | 100 UNITS |

Each combination of weights of chips has a unique wagering value, within limits of wagers of chips, as indicated and described above.

Aspects of the invention include a system for determining values of wagers at a wagering position in which there is an electronic weight-sensing system at the wagering system, a set of different value wagering chips having different values in subsets of chips, and each subset of chips having relative non-rational weight values, the electronic weight-sensing system in information communication link with a processor, and the processor is configured to determine from sensed weight at the wagering position value amounts from the wagers at the wagering position. The processor may be configured with a look-up table against which sensed weight is compared to determine a unique total value of wagers at the wagering position when multiple chips having different relative non-rational weight values are present at the wagering position. The processor may be configured to execute code with respect to sensed weight to determine a unique total value of wagers at the wagering position when multiple chips having different relative non-rational weight values are present at the wagering position. The system may have a supplemental system for determining values of wagers at a wagering position having at least an electronic weight-sensing system at the wagering system, a set of different value wagering chips having different values in subsets of chips, and each subset of chips having relative non-rational weight values, the electronic weight-sensing system in information communication link with a processor, and the processor is configured to determine from sensed weight at the wagering position value amounts from the wagers at the wagering position.

A method may be used to determine total values of wagers at a single player's wagering position on a gaming table by: a) providing a set of different value wagering chips having different values in subsets of chips, and each subset of chips having relative non-rational weight values, b) a wager placed at a least one wagering position with at least one chip from a subset of chips, c) weighing the wager placed at the at least one wagering position, and d) accurately determining a total value of wagers made at the at least one wagering system based on unique correspondence between weight and value among each subset of chips. A number of chips at the at least one wagering position is sensed and the number of chips and a total weight of chips at the at least one wagering position are used in combination to determine the total value of wagers made at the at least one wagering position.

It is also possible within the scope of the present technology to use chips that are translucent to infrared radiation, such that multiple chips may be identified and counted using this system. By using chips, tokens or markers that are transparent or preferably only translucent to infrared radiation (or even in combination with or exclusively with visible radiation and/or UV radiation, and not necessarily requiring transparency of the markings, fiducials, inlusions, etc. used to identify value)), the camera system (overhead or even reflective) may be used to read numbers of chips and even amounts of value in chips. As the translucent chips can be provided with radiation attenuating fiducials, markings, identification marks, pattern or symbols, differing optical densities to the emitted radiation, and the like which can identify the value of chips, the radiation transmitted through the chips can be used to count chips and total values of chips being wagered at a specific position. This is shown in FIG. 5, which shows the following patterns and markings identifying numbers and values of chips in single images, even through multiple chips. The features of the chips are shown without separately distinguishing the chips as overlying or underlying, as the actual images created by the penetrating radiation show all edge features and markings, as would an X-ray, so that the FIG. 5 images (5A, 5B, 5C, 5D, 5E, 5F, 5G and 5H) show realistic rendition showing all features of all chips. It is to be noted that the valuing of chips by these methodologies can be used not only for wagers, but also for payouts by the casino and for cashing in chips. The chip valuation can also be manually verified, but the electronic verification (with or without verification) can be used in accounting functions for individual players and for the total number of players at the table. There may be multiple weighing positions at each player position, as different games may have different numbers of distinct wagers, as in Three-Card Poker™ games, Four-Card Poker™ games, Ultimate Texas Hold'Em™ poker games, Pai Gow Bonus™ poker games and the like. By using these accurate wager, payout and cash-out (cashed-in) value determinations and the use of card-reading and hand reading, and hand evaluation systems, a complete record of a game played can be recorded, verified and controlled to prevent fraud and error.

FIG. 3 shows a side cutaway view of a gaming table 600, under-table lighting system 610 and camera system 612, and weighing system 614 for chips enabling practice of one aspect of the present technology. The table 600 has a top radiation translucent/transparent support surface 604 supporting a top layer 602 which may be traditional felt or special radiation (e.g., UV, visible or IR) transparent covering. Individual wagering areas 614 have at least a portion of a weighing system associated therewith, as the weight sensors 618 and their communication link 616 to the weighing areas. Non-wired (e.g., RF) communication links may also be used. At the bottom of the table 600 may be a base support layer 608, supporting a layer 606 having light(s) 610 that emit the desired radiation upwardly through layers 604 and 602 to the camera 612.

FIG. 5A shows a single chip 550 with a nominal value of 1 unit having unique radiation attenuating marking 550a identifying the chip as a 1 unit chip.

FIG. 5B shows a single chip 552 with a nominal value of 5 units having unique radiation attenuating marking 552a identifying the chip as a 5 unit chip.

FIG. 5C shows a single chip 554 with a nominal value of 25 units having unique radiation attenuating marking 554a identifying the chip as a 25 unit chip.

FIG. 5D shows a single chip 556 with a nominal value of 100 units having unique radiation attenuating marking 556a identifying the chip as a 100 unit chip.

FIG. 5E shows two chips 550, 554 overlying each other. The two distinct markings 550a, 554a attenuating emitted radiation are shown as distinct elements of the image that can be optically read by a distal viewer having the infrared image converted to a visible display, or by purely mechanical means, with an image reader interpreting the distinct markings.

FIG. 5F shows three chips 550, 554, 556 overlying each other. The three distinct markings 550a, 554a, 556a attenuating emitted radiation are shown as distinct elements of the image that can be optically read by a distal viewer having the infrared image converted to a visible display, or by purely mechanical means, with an image reader interpreting the distinct markings. The automatic reading function would identify one chip each of 1 unit value, 25 unit value and 100 unit value and total that as 126 units wagered at that position.

FIG. 5G shows four chips 550, 552, 554, 556 overlying each other. The four distinct markings 550a, 552a, 554a, 556a attenuating emitted radiation are shown as distinct elements of the image that can be optically read by a distal viewer having the infrared image converted to a visible display, or by purely mechanical means, with an image reader interpreting the distinct markings. The automatic reading function would identify one chip each of 1 unit value, 5 unit value, 25 unit value and 100 unit value and total that as 131 units wagered at that position.

Note that the image in FIG. 5G is of four perfectly overlain and aligned chips of different values, and that each chip marking is distinctly viewable because the markings are impossible to be positioned where one marking completely blocks reading of a different marking because of positioning and size, and location of markings. Even the similar markings of FIG. 5E can never be confused. Modern chips tend to vary in weight among different casinos in the U.S., with disclosed weights between about 8 and 14 grams/chip, typically between 8.3 g and 12.5 g per chip. In the practice of the present technology, greater standardization may be provided or each casino can use its own unique weight of chips. A single system may be self-educating and can be customized and self-adjusting for weights of chips. For example, at the beginning of each day or shift change, one single chip (at a time) and then collectively one of each chip at the same time. The system will self-adjust and self-calibrate for the chips of the actual weight (whether unique or not) used at that facility. This self-calibration will assure that the weight-sensing system if functional and accurate each day and even for each session (which may be 2, 4, 6, or 8 hours).

It is possible that chips of similar value can be precisely positioned such that identical markings may be perfectly aligned in a perfectly vertical emission, penetration and receiving of the emitted radiation image. Even with a small probability of this occurring, the use of an accompanying weighing function (as described above) in combination with the value reading would indicate to the server or observer that there is a deficiency in the reading at a particular position. However, having the radiation emission, the direction (angle) in which radiation passes through the stack of chips, and the angle at which a camera receives the transmitted radiation image will alleviate this issue. As shown in FIG. 5H, with this angularity of transmission of the radiation, a perfect stack would have the appearance of being off-set. This would prevent readings that would completely obscure underlying values, even if aligned along a vertical perspective. As shown in FIG. 5H, two one unit chips 550 are in a stack, one on the top of the stack and one on the bottom of the stack. The stack is in perfect vertical alignment, with all chips concentric. However, because of the angularity of the radiation creating the image, the two 1 unit markings 550a are clearly and separately visible.

Therefore, another distinct aspect of the see-through technology described herein includes the use of see-through (radiation transmissive or translucent) chips having markings thereon that can distinguish there value based on different imagery produced by different optical and opaque and attenuating image density within the chips.

Therefore a method within the present technology may be used including a method that reads information from a chip or marker while one or more chips are stacked on a gaming surface (e.g., table). The chips are at least translucent to specific wavelengths of radiation, such as the IR portion of the spectrum. An infrared-sensitive camera (which may be the same camera used to identify individual playing cards) may be used over the chips to identify individual chips and collections of chips by number of chips and value of chips. The term over means on an opposite side of the chip from the source of radiation that penetrates the translucent chip. The camera receives infrared information passing through the chip. A filter on the camera filters out at least some visible and some infrared radiation (infrared radiation is defined herein as radiation above 700 nm wavelengths up to 2300 nm, preferably at least 750 nm or at least 780 nm up to about 2300 nm), allowing a defined range of infrared radiation into the camera. The camera captures radiation within the defined range of radiation and transmits (and/or temporarily stores) signals based on the captured radiation. A processor receives the transmitted signals and executes code to define patterns in the captured radiation. The defined patterns include image content of numbers of chips and values of chips as indicated above. With chip reading, chips transparent to visible radiation and visible light sensitive cameras may be used, but that light might be more annoying to players.

What is claimed:

1. A system for determining values of wagers at a wagering position comprising an electronic weight-sensing system at the wagering position, a set of at least three different value wagering chips having different values in subsets of chips, and each subset of chips having relative non-rational weight values within a group of at least 10 chips with at least one chip from each of the three subsets, the electronic weight-sensing system in information communication link with a processor, and the processor is configured to determine from sensed weight at the wagering position actual total value amounts from the wagers in a single stack at the wagering position.

2. The system of claim 1 wherein the processor is configured with a look-up table against which sensed weight is compared to determine a unique total value of wagers at the wagering position when multiple chips having different relative non-rational weight values are present at the wagering position.

3. The system of claim 1 wherein the processor is configured to execute code with respect to sensed weight to determine a unique total value of wagers at the wagering position when multiple chips having different relative non-rational weight values are present at the wagering position.

4. The system of claim 1 further comprising a system for determining values of wagers, awards or cashed-in chips at a wagering position comprising an electronic weight-sensing system at the wagering system, a set of different value wagering chips having different values in subsets of chips, and each subset of chips having relative non-rational weight values, the electronic weight-sensing system in information communication link with a processor, and the processor is configured to determine from sensed weight at the wagering position value amounts from the wagers at the wagering position.

5. The system of claim 1 wherein an automated chip counting system is present in combination with the weight sensing system at the wagering position.

6. The system of claim 5 wherein the automated chip counting system comprises a radiation emitter and a camera sensitive to wavelengths of the emitted radiation, the camera in communication link with the processor.

7. The system of claim 2 wherein an automated chip counting system is present in combination with the weight sensing system at the wagering position.

8. The system of claim 4 wherein an automated chip counting system is present in combination with the weight sensing system at the wagering position.

9. The system of claim 8 wherein the automated chip counting system comprises a radiation emitter and a camera sensitive to wavelengths of the emitted radiation, the camera in communication link with the processor.

10. A method of determining total values of wagers, payouts or cashed-in chips at a single player's wagering position on a gaming table comprising: a) providing a set of at least three different value wagering chips having different values in subsets of chips, and each subset of chips having relative non-rational weight values, b) placing chips at a least one weighing position with at least one chip from a subset of chips, c) weighing the wager placed at the at least one weighing position, and d) accurately determining a total value of wagers made at the at least one weighing system based on unique correspondence between weight and value among each subset of chips, wherein each subset of chips has non-rational weights such that for any combination of ten chips from each of the at least three subsets of chips, there is a unique weight.

11. The method of claim 10 wherein a number of chips at the at least one weighing position is sensed and the number of chips and a total weight of chips at the at least one weighing position are used in combination to determine the total value of wagers made at the at least one weighing position.

12. The method of claim 10 wherein at least three chips of at least three different values are weighed at the same time at the at least one wagering position.

13. The method of claim 11 wherein at least three chips of at least three different values are weighed at the same time at the at least one wagering position.

14. The method of claim 11 wherein numbers of chips are automatically identified by an image capture system.

15. The method of claim 12 wherein numbers of chips are automatically identified by an image capture system.

16. The method of claim 13 wherein numbers of chips are automatically identified by an image capture system.
